(19) United States
(12) Patent Application Publication
(10) Pub. No.: US 2004/0028365 A1
(43) Pub. Date: Feb. 12, 2004

(54) Metal oxide coated fiber and methods for coating an optical fiber with a metal oxide coating

(76) Inventors: Abds-Sami Malik, Somerset, NJ (US); Janet Mrotek, Somerset, NJ (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/215,838

(22) Filed: Aug. 9, 2002

(51) Int. Cl. G02B 6/22; B05D 5/06

(52) U.S. Cl. 385/128; 385/141; 427/163.2

(57) ABSTRACT

A metal oxide coated fiber and methods for coating an optical fiber with a metal oxide coating are provided. One embodiment of the metal oxide coated fiber comprises a core; a cladding surrounding the core; and a metal oxide coating surrounding the cladding. One embodiment of the methods comprises dipping the fiber in a solution to deposit a layer of a metal oxide; and annealing the fiber to form a metal oxide coating on the fiber.

### TECHNICAL FIELD

The present invention is generally related to coatings for optical fibers and, more particularly, is related to a metal oxide coated fiber and methods for coating an optical fiber with a metal oxide coating.

### BACKGROUND OF THE INVENTION

During an optical fiber manufacturing process, a coating of a polymer is applied to each optical fiber to provide protection from mechanical damage to the fibers. Each optical fiber is typically made of silica—glass. Examples of polymers include acrylates and polyimide.

The polymer coating provides protection from mechanical damage to the fibers since if the polymer coating is removed, the fibers become susceptible to mechanical damage when a user handles the fiber. For instance, during a grating manufacturing process, when gratings, such as, for instance, fiber Bragg gratings (FBG) are written in the fibers, the polymer coating is removed. After the polymer is removed, handling or transportation of the fibers from one place to another can render the fibers susceptible to nicks, cracks, and scratches, and being damaged by touching with fingers.

Moreover, the polymer coating has been found to improve the fatigue resistance of the fibers by altering the surface chemistry of the silica of the fibers. If the fibers are not coated with the polymer coating or if the polymer coating is removed, the fibers may become less resistant to fatigue so that the fibers are more susceptible to corrosion and become weaker with the passage of time by being exposed to the moisture.

During the grating manufacturing process, it is typical to remove the polymer coating surrounding a fiber, write the gratings, and then reapply the polymer coating to the fiber. The reason for removing when the gratings are written to the fiber is that the fiber is typically exposed to ultraviolet radiation to write the gratings and the polymer coating, generally, is not transparent to ultraviolet radiation. Non-transparency to ultraviolet radiation means that the polymer coating absorbs the ultraviolet radiation. When the polymer coating absorbs the ultraviolet radiation, the polymer coating undergoes photo-darkening and charring. The absorption of the ultraviolet radiation also reduces the amount of ultraviolet radiation that reaches the fiber and thus interferes with the process of writing the gratings in the fiber. The polymer coating, therefore, is typically removed during the grating manufacturing process and then coated again on the fiber after the gratings are written since the polymer coating, generally, is not transparent to ultraviolet radiation.

However, the removal of the polymer coating renders the fiber susceptible to mechanical damage and fatigue. Moreover, recoating the fiber with a polymer coating after writing the gratings in the fiber requires additional time and effort.

Furthermore, the polymer coating cannot withstand temperatures exceeding 200° centigrade without charring and degrading. So, the polymer coating cannot be applied to the fiber when the fiber is to be subjected to temperatures exceeding 200° centigrade.

3M Corporation coats a fiber with a diamond-like coating. The diamond-like coating protects the fiber from mechanical damage since diamond is harder than the silica of the fiber. It also provides protection in high temperature applications and is ultraviolet transparent. However, the diamond-like coating is difficult to manufacture since complicated machinery, such as for instance, a low pressure chamber is used to apply the diamond-like coating. The complicated machinery is used to deposit the diamond-like coating from vapor. A user should be well-trained before using the complicated machinery to manufacture the diamond-like coating.

Moreover, an optical fiber cannot be coated with the diamond-like coating when drawing the fiber from glass during an optical fiber manufacturing process. The reason why the diamond-like coating cannot be applied during the optical fiber manufacturing process is that the diamond-like coating cannot be deposited on the fiber at a rate from 1 to 10 meters per second, which is typically the rate at which the fiber is drawn. Currently, once the fiber is drawn during the optical fiber manufacturing process, the acrylate coating of the fiber is removed. The fiber is then placed in the machinery to apply the diamond-like coating, which takes much longer than the rate at which the fiber is drawn. Hence, the process of applying the diamond-like coating cannot be used when the fiber is drawn because the process of applying the diamond-like coating is slower than the rate at which the fiber is drawn.

Hence, a need exists in the industry to overcome at least the above-mentioned inadequacies of being unable to write gratings without first removing the polymer coating, the polymer coating being unable to withstand high temperatures, using complicated machinery to manufacture a hard coating such as the diamond-like coating, and being unable to apply the hard coating when drawing a fiber.

### SUMMARY OF THE INVENTION

Embodiments of the present invention provide a metal oxide coated fiber and methods for coating an optical fiber with a metal oxide coating. Briefly described, in architecture, one embodiment of the metal oxide coated fiber, among others, can be implemented as follows. A metal oxide coated fiber comprising a core; a cladding surrounding the core; and a metal oxide coating surrounding the cladding.

Embodiments of the present invention can also be viewed as providing methods for coating an optical fiber with a metal oxide coating. In this regard, one embodiment of such methods, among others, can be broadly summarized by the following steps: dipping the fiber in a solution to deposit a layer of a metal oxide; and annealing the fiber to form a metal oxide coating on the fiber.

The metal oxide coated fiber and methods for coating an optical fiber with a metal oxide coating avoids the above inadequacies because there is no need to remove the metal oxide coating when writing gratings in the fiber. Moreover, the metal oxide coating allows the fibers coated with the metal oxide coating to be used in high temperature applications since fibers coated with the metal oxide coating can withstand high temperatures, such as, for instance, between 150° centigrade and 500° centigrade. Furthermore, no complicated machinery needs to be utilized to apply the metal oxide coating to an optical fiber since the methods for coating an optical fiber with a metal oxide coating can be performed by a user with minimal training. Additionally, the metal oxide coating can be applied during the optical fiber manufacturing process because the metal oxide coating can be applied using technology similar to technology used to apply a polymer coating and the polymer coating can be applied during the optical fiber manufacturing process.

Other features and advantages of the present invention will be or become apparent to one with skill in the art upon examination of the following drawings and detailed description. It is intended that all such additional features and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a cross sectional view of an embodiment of a typical polymer coated fiber.

FIG. 1B is an isometric view of the polymer coated fiber of FIG. 1A.

FIG. 2A is a cross sectional view of an embodiment of an optical fiber coated with a metal oxide coating that is in direct contact with a cladding of the optical fiber.

FIG. 2B is an isometric view of the optical fiber of FIG. 2A that is coated with the metal oxide coating of FIG. 2A that is in direct contact with the optical fiber.

FIG. 3A is a cross sectional view of an embodiment of the optical fiber of FIG. 2A with the metal oxide coating of FIG. 2A and an additional protective coating.

FIG. 3B is an isometric view of an embodiment of the fiber of FIG. 3A with the metal oxide coating of FIG. 3A and the additional protective coating of FIG. 3A that surrounds the metal oxide coating.

FIG. 4 is a flow chart of an embodiment of a method for coating an optical fiber.

FIG. 5 is a plot of ultraviolet spectra showing that the metal oxide coating of FIG. 2A is transparent to ultraviolet radiation.

FIG. 6 is a plot of failure stress versus stress rate showing that the metal oxide coating of FIG. 2A provides fatigue resistance to the optical fiber of FIG. 2A.

FIG. 7 is a Weibull plot showing a distribution of failure strengths of the optical fiber of FIG. 1A coated with the polymer coating of FIG. 1B and a distribution of failure strengths of the optical fiber coated with the metal oxide coating of FIG. 2B.

### DETAILED DESCRIPTION

A metal oxide coated fiber and methods for coating an optical fiber with a metal oxide coating are provided. An optical fiber coated with a metal oxide coating avoids the above-mentioned inadequacies since the metal oxide coating need not be removed during the grating manufacturing process, thereby simultaneously allowing writing the gratings and protecting the fiber from mechanical damage. The metal oxide coating need not be removed during the grating manufacturing process since the metal oxide coating is transparent to ultraviolet radiation. The metal oxide coating protects the fiber from mechanical damage during writing of the gratings since the metal oxide coating need not be removed from the fiber coated with the metal oxide coating when writing the gratings and the metal oxide coating provides a distribution of failure strengths to the fiber that is substantially the same as the distribution of failure strengths provided by the polymer coating. Moreover, the metal oxide coating has a hardness that can protect the fiber from mechanical damage.

Furthermore, optical fibers coated with the metal oxide coating can be cleaved and spliced. The fibers coated with the metal oxide coating can be spliced together since the metal oxide coating does not interfere with the splicing. Additionally, the fibers coated with the metal oxide coating can also be used in high temperature applications since the metal oxide coating can withstand high temperatures, such as, for instance, between 150° centigrade and 500° centigrade. Moreover, no complicated machinery needs to be used to apply the metal oxide coating and the metal oxide coating can be applied when drawing an optical fiber during the optical fiber manufacturing process. No complicated machinery needs to be used because a user with minimal training can use the methods for coating the fiber with the metal oxide coating, which are discussed below in detail. The metal oxide coating can be applied when a fiber is drawn since a polymer coating can be applied to the fiber when the fiber is drawn and the metal oxide coating can be applied using a similar technology by which the polymer coating is applied to the fiber.

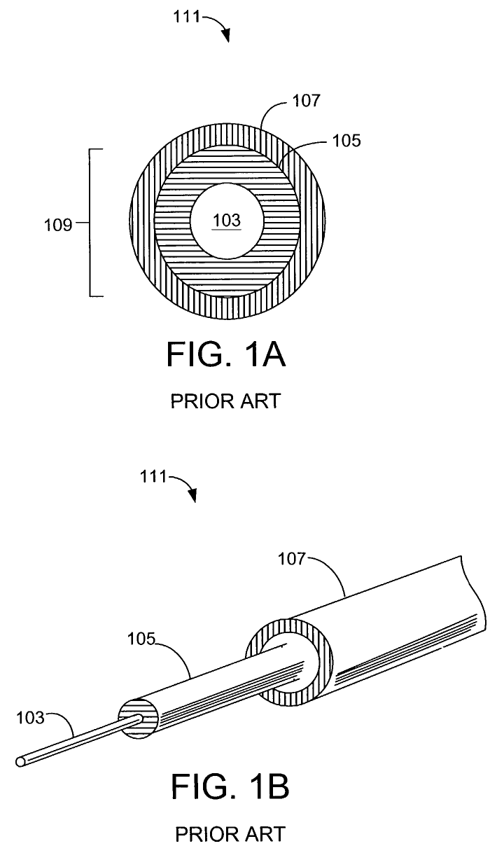

FIG. 1A is a cross sectional view of an embodiment of a typical polymer coated fiber 111. FIG. 1B is an isometric view of the polymer coated fiber 111 of FIG. 1A. The polymer coated fiber 111 comprises an optical fiber 109 and a polymer coating 107 that is in direct contact with the a cladding 105 of the fiber 109. The polymer coating 107 is in direct contact with the cladding 105 since there is no layer between the polymer coating 107 and the cladding 105.

The fiber 109 comprises a core 103 and the cladding 105. The core 103 and the cladding 105 are typically made of silica—glass. The polymer coating 107 is typically made of one or more polymers. Examples of polymers include acrylates and polyimides. The polymer coating 107 protects the fiber 109 from mechanical damage. For instance, the fiber 109 without the polymer coating 107 is susceptible to scratches, nicks, cracks, and being damaged by touching with fingers. Additionally, the polymer coating 107 can improve the fatigue resistance of the fiber 109 so that the fiber 109 with the polymer coating 107 will maintain its strength for a longer period of time in a moist environment than the fiber 109 without the polymer coating 107.

However, during the grating manufacturing process, typically, the polymer coating 107 is removed to write the gratings in the fiber 109. The reason for typically removing the polymer coating 107 when writing the gratings is that the polymer coating 107 is not transparent to ultraviolet radiation and so interferes with writing the gratings. The polymer coating 107 is not transparent to ultraviolet radiation because the polymer coating 107 suffers from photo-darkening and charring when exposed to ultraviolet radiation. The photo-darkening is a result of the polymer coating 107 absorbing the ultraviolet radiation, thereby reducing the amount of ultraviolet radiation that reaches the fiber 109 to write the gratings in the fiber 109. The polymer coating 107, therefore, is removed before writing the gratings in the fiber 109. Nevertheless, the removal of the polymer coating 107 renders the fiber 109 susceptible to mechanical damage and fatigue. Moreover, fibers coated with the polymer coating 107 cannot be used in high temperature applications since the polymer coating 107 will char and degrade when the fibers are subjected to temperatures exceeding 200° centigrade.

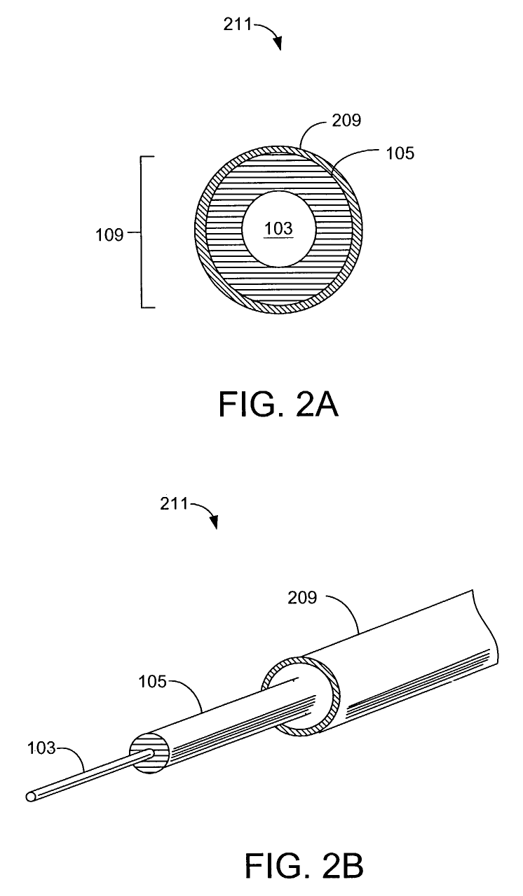

FIG. 2A is a cross sectional view of an embodiment of the fiber 109 coated with a metal oxide coating 209 that is in direct contact with the cladding 105 of the fiber 109. FIG. 2B is an isometric view of the fiber 109 of FIG. 2A that is coated with the metal oxide coating 209 that is in direct contact with the fiber 109. The metal oxide coating 209 is in direct contact with the fiber 109 since there is no layer between the metal oxide coating 209 and the fiber 109. The metal oxide coating 209 is made of a metal oxide. Examples of metal oxides include, but are not limited to, vanadium oxide, titanium oxide, and aluminum oxide. The metal oxide coating preferably can be between 0 and 1 micrometer thick.

The metal oxide coating 209 need not be removed during the grating manufacturing process since the metal oxide coating does not interfere with the writing of the gratings. The metal oxide coating 209 is transparent to ultraviolet radiation and so it does not interfere with the writing of gratings in the fiber 109. The metal oxide coating 209 is transparent to ultraviolet radiation since it does not photo-darken or char when the fiber 109 is subjected to ultraviolet radiation to write the gratings in the fiber 109. The metal oxide coated fiber 211, typically, is subjected to ultraviolet radiation with a wavelength of 240 to 250 nanometers to write the gratings in the fiber 109.

The metal oxide coating 209 simultaneously protects the fiber 109 from mechanical damage, such as, for instance, scratches, nicks, cracks, and contact with the hands of a user, during the grating manufacturing process. The metal oxide coating 209 simultaneously provides protection from mechanical damage to the fiber 109 during the grating manufacturing process since the metal oxide coating 209 need not be removed during the grating manufacturing process and as is explained below in detail, the distribution of failure strengths of the metal oxide coating 209 is substantially the same as the distribution of failure strengths of the polymer coating 107 (FIG. 1A). Another reason that the metal oxide coating 209 protects the fiber 109 against mechanical damage is that the metal oxide of the metal oxide coating 209 has a hardness that provides such protection. For instance, an aluminum oxide coating protects the fiber 109 from mechanical damage because the aluminum oxide of the aluminum oxide coating has a hardness of 9 on the Mohs scale as compared to silica of the fiber 109 that has a hardness of 7. Furthermore, the metal oxide coating 209 does not char or degrade when subjected to high temperatures, such as, for example, between 150° centigrade and 500° centigrade. Moreover, the metal oxide coating 209 may protect the fiber 109 from coming into contact with water and provides fatigue resistance to the fiber 109. The fiber 109 coated with the metal oxide coating 209 is more resistant to moisture than the fiber 109 without the metal oxide coating 209 and so the fiber 109 without the metal oxide coating 209 becomes weaker at a faster rate in the presence of moisture than the fiber 109 with the metal oxide coating 209.

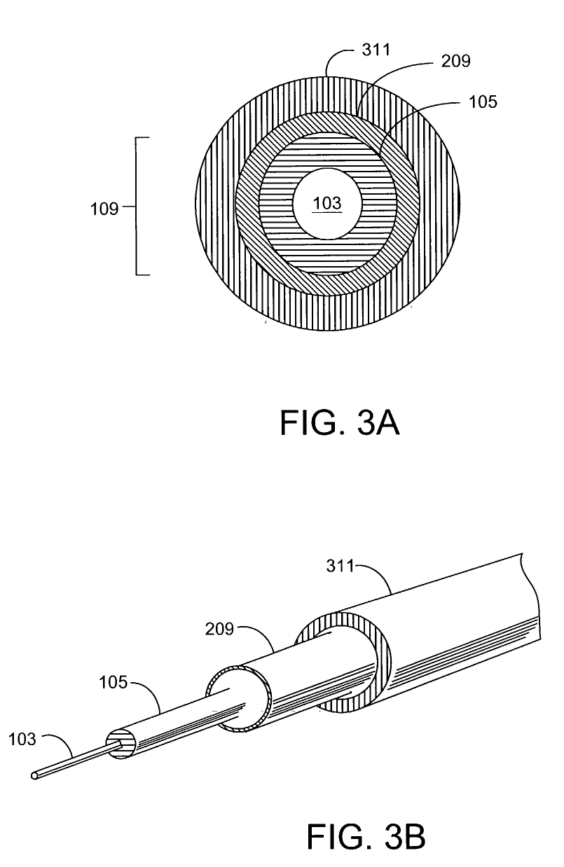

FIG. 3A is a cross sectional view of an embodiment of the fiber 109 with the metal oxide coating 209 and an additional protective coating 311. FIG. 3B is an isometric view of an embodiment of the fiber 109 of FIG. 3A with the metal oxide coating 209 and the protective coating 311 that surrounds the metal oxide coating 209. The metal oxide coating 209 is in direct contact with the fiber 109 and the protective coating 311 surrounds the metal oxide coating 209. The protective coating 311 is typically a polymer coating, such as the polymer coating 107 (FIG. 1B). An optical fiber that is surrounded by the metal oxide coating 209 and the protective coating 311 receives the advantages of the protective coating 311 and the metal oxide coating 209. As an illustration, the fiber 109 that is surrounded by the metal oxide coating 209 and the polymer coating 107 receives the advantages of the metal oxide coating 209 and the polymer coating 107.

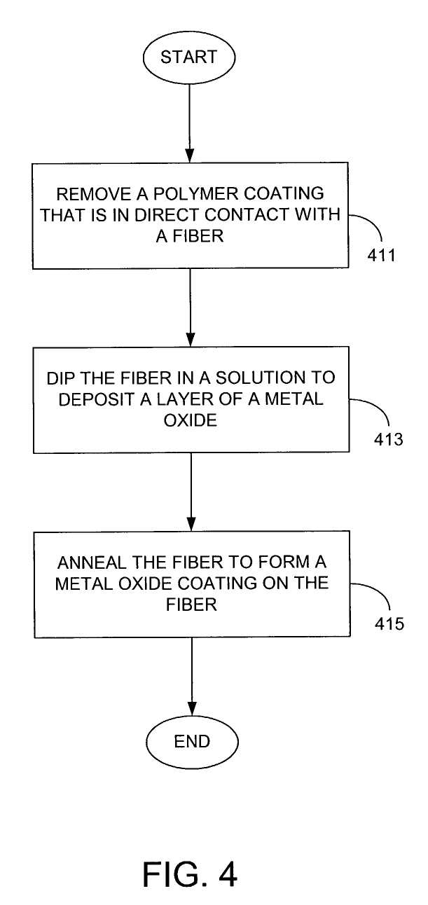

FIG. 4 is a flow chart of an embodiment of a method for coating an optical fiber. Any process descriptions or blocks in this or other flow charts in this method should be understood as representing modules, segments, or portions of code which include one or more executable instructions for implementing specific logical functions or steps in the method, and alternate implementations are included within the scope of the preferred embodiment of the methods for coating an optical fiber in which functions may be executed out of order from that shown or discussed, including substantially concurrently or in reverse order, depending on the functionality involved, as would be understood by those reasonably skilled in the art of the present invention.

The method starts with a step 411 of removing the polymer coating 107 (FIG. 1A) that is in direct contact with the fiber 109 (FIG. 1A). Typically, the polymer coating 107 is removed by immersing the polymer coated fiber 111 (FIG. 1A) in a hot acid, such as, for instance, hot sulfuric acid, hot hydrochloric acid, or hot nitric acid. For instance, the polymer coated fiber 111 is immersed into sulfuric acid at 140° centigrade for 30 seconds to remove the polymer coating 107. In an alternative embodiment, the polymer coating 107 can be removed by heated mechanical stripping where the polymer coating 107 is heated to soften the polymer coating 107 and then scraped from the polymer coated fiber 111. It should be noted that the step 411 assumes that the fiber 109 is coated with a polymer coating 107. If the fiber 109 is not coated with the polymer coating 107, the step 411 is not performed since there is no polymer coating to remove.

Once the polymer coating is removed, the fiber 109 can be cleansed by dipping the fiber 109 in alcohol and providing an ultrasonic bath of alcohol to the fiber 109. For instance, the fiber 109 can be cleansed by dipping the fiber 109 into two different containers of methanol for one minute in each container, then providing an ultrasonic bath of isopropanol for two minutes, and then dipping the fiber 109 in distilled water (H₂O) for two minutes. Alternatively, the fiber 109 can be cleansed by dipping the fiber 109 in alcohol and providing an ultrasonic bath of water to the fiber 109. The cleansing may not be performed after removing the polymer coating 107.

In step 413, the fiber 109 is dipped into a solution to deposit a layer of a metal oxide. For example, the fiber 109 is dipped into a metal alkoxide solution for a certain amount of time, such as, for instance, in vanadium isopropoxide solution for one hour to deposit a layer of the corresponding metal oxide, such as vanadium oxide on the fiber 109. When the fiber 109 is dipped into the metal alkoxide solution, the silica of the fiber 109 reacts to form, for instance, a covalent bond with the metal isopropoxide of the metal alkoxide solution to deposit a layer of the corresponding metal oxide on the fiber 109. Details of the chemical reaction between a vanadium isopropoxide solution and silica are provided in M. Morey, A. Davidson, H. Eckert, G. Stucky, Chem. Mater. 8, 486-492 (1996) which is incorporated by reference herein in its entirety. It should be noted that the fiber 109 is dipped into a metal alkoxide solution, such as, for instance, vanadium isopropoxide solution, under an inert atmosphere, if the metal alkoxide of the metal alkoxide solution is highly reactive to moisture.

As another example, the fiber 109 can be dipped into an aqueous metal oxide solution to form a layer of the corresponding metal oxide on the fiber 109. An aqueous metal oxide solution can be formed by reacting a metal alkoxide with water to form a metal oxide suspension, and then peptizing the metal oxide suspension with a concentrated acid, such as, for instance, hydrochloric acid. As an illustration, which is described in Yoldas B. E. American Ceramic Society Bulletin, 1975, 54, 289-90, which is incorporated by reference herein in its entirety, one gram of aluminum butoxide is reacted with eight milliliters of hot water to form an alumina suspension. The alumina suspension is then peptized with two drops of concentrated hydrochloric acid to form an aqueous aluminum oxide solution. It should be noted that the fiber 109 can be dipped into an aqueous metal oxide solution under air, at room temperature, since the aqueous metal oxide solution is not highly reactive to moisture.

After dipping the fiber into a metal oxide solution to form a layer of the corresponding metal oxide, in step 415, the fiber 109 is annealed to form the metal oxide coating 209 (FIG. 2A). For instance, the fiber 109 can be annealed by heating the fiber 109 between 200° centigrade and 400° centigrade in a furnace in the presence of air to form the metal oxide coating 209. As another instance, the fiber 109 can be placed in a furnace at 250° centigrade for some time up to four hours to form a vanadium oxide coating on the fiber 109.

Complicated machinery such as that used by 3M Corporation is not required to implement the methods for coating an optical fiber with a metal oxide coating because a user with minimal training can implement the methods to make the metal oxide coated fiber 211 (FIG. 2A). Moreover, the metal oxide coating 209 can be applied when the fiber 109 is drawn during the optical fiber manufacturing process because technology similar to the technology that is used to apply the polymer coating 107 on the fiber 109 can be used to apply the metal oxide coating 209 on the fiber 109 and the polymer coating 107 is applied when the fiber 109 is drawn.

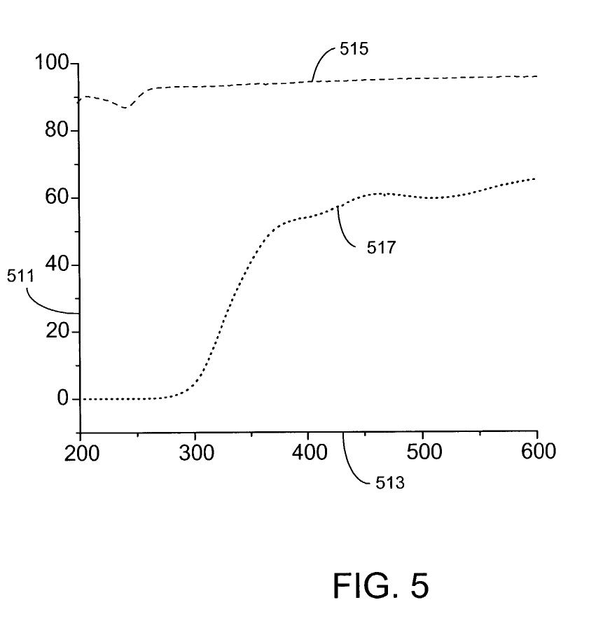

FIG. 5 is a plot of ultraviolet (UV) spectra showing that the metal oxide coating 209 (FIG. 2A) is transparent to ultraviolet radiation. The UV spectra plots transmittance measured in percentage, on axis 511, versus wavelength measured in nanometers, on axis 513. Curve 515 is a UV spectra of an aluminum oxide coating on the fiber 109 (FIG. 2A) and curve 517 is a UV spectra of a vanadium oxide coating on the fiber 109. The aluminum oxide coating is transparent to ultraviolet radiation that the aluminum oxide coated fiber is subjected to because the aluminum oxide coating has a 80% to 90% transmittance when subjected to an ultraviolet radiation of 200 nanometers to 600 nanometers wavelength. The 80% to 90% transmittance means that 80% to 90% of the ultraviolet radiation passes through the aluminum oxide coating to reach the fiber 109. Moreover, the vanadium oxide coating is transparent to ultraviolet radiation that the vanadium oxide coated fiber is subjected to because the vanadium oxide coating has approximately 50% transmittance when subjected to an ultraviolet radiation of 350 to 600 nanometers wavelength. Approximately 50% of the ultraviolet radiation passes through the vanadium oxide coating to reach the fiber 109. Hence, the metal oxide coating 209 is transparent to ultraviolet radiation.

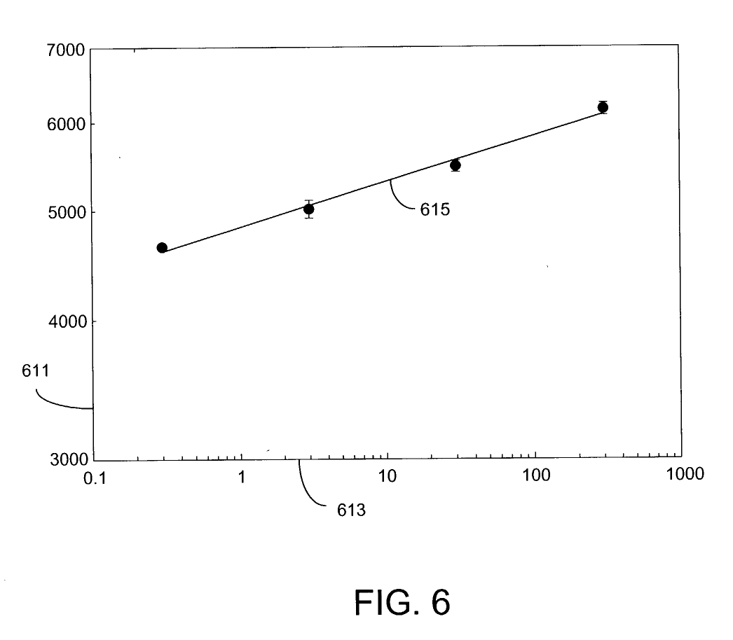

FIG. 6 is a plot of failure stress versus stress rate showing that the metal oxide coating 209 (FIG. 2A) provides fatigue resistance to the fiber 109 (FIG. 2A). The plot of FIG. 6 plots failure stress in megapascals (MPa), on axis 611, versus stress rate, in MPa per second (MPa/s), on axis 613 for the fiber 109 coated with a vanadium oxide coating. The four data points in the plot were measured at an RH of 50%, in 2-point bending, and at a constant temperature of 23° centigrade. Each of the four data points were averaged over fifteen samples.

The slope of a line 615 connecting the four data points is 0.0407, and so a fatigue perimeter, which is provided by subtracting one from the inverse of the slope of the line 615, of the fiber 109 coated with the vanadium oxide coating is 23.57. According to the Telecordia standard GR-20-CORE, fatigue parameter for the polymer coated fiber 111 should be at least 18. Therefore, the fiber 109 coated with the vanadium oxide coating satisfies the Telecordia standard. Hence, the metal oxide coating 209 provides fatigue resistance to the fiber 109.

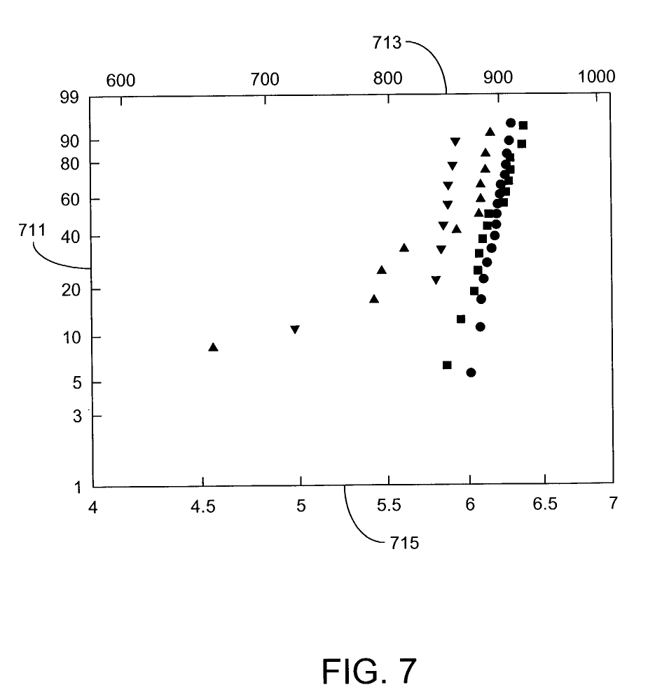

FIG. 7 is a Weibull plot showing a distribution of failure strengths of the fiber 109 (FIG. 1A) coated with the polymer coating 107 (FIG. 1B) and a distribution of failure strengths of the fiber 109 coated with the metal oxide coating 209 (FIG. 2A). The Weibull plot plots frequency probability, in percentage, on axis 711 versus failure stress. The failure stress is measured in gigapascals (GPa) on axis 715 and in kilopounds per square inch (KSI) on axis 713.

Triangles with a vertex pointing up represent a distribution of failure strengths of the fiber 109, triangles with a vertex pointing down represent a distribution of failure strengths of an aluminum oxide coated fiber, squares represent a distribution of failure strengths of a vanadium oxide coated fiber, and circles represent a distribution of failure strengths of the polymer coated fiber 111 (FIG. 1B). The failure strengths are measured at a constant stress rate, constant temperature, and constant relative humidity. For instance, the failure strengths in the Weibull plot were measured at a constant stress rate of 300 megapascals per second (MPa) in 2-point bending, at a constant temperature of 23° centigrade, and at a relative humidity (RH) of 50%.

It is evident from the squares and the circles that the distribution of failure strengths of the vanadium oxide coated fiber is substantially the same as the distribution of failure strengths of the polymer coated fiber 111. Furthermore, it is evident from the triangles with a vertex pointing down and the circles that the distribution of failure strengths of the aluminum oxide coated fiber is substantially the same as the polymer coated fiber 111. Therefore, distribution of failure strengths of the metal oxide coated fiber 211 is substantially the same as the polymer coated fiber 111. Hence, the metal oxide coating 209 provides protection to the fiber 109 from mechanical damage.

Moreover, the metal oxide coating 209 does not weaken the fiber 109 since the distribution of failure strengths of the polymer coated fiber 111 and the metal oxide coated fiber 211 is substantially the same. Additionally, according to Telecordia standard GR-20-CORE, the metal oxide coated fiber 211 should have a Weibull modulus m of at least 30. The larger the Weibull modulus, the tighter the distribution of failure strengths. In the Weibull plot, the fiber 109 had a Weibull modulus of 17.3, the polymer coated fiber 111 had a Weibull modulus of 96, the fiber 109 coated with an aluminum oxide coating had a Weibull modulus of 36 and the fiber 109 with a vanadium oxide coating had a Weibull modulus of 46. Hence, generally, the metal oxide coated fiber 211 has a Weibull modulus of at least 30, as suggested by the Telecordia standard.

It should be emphasized that the above-described embodiments of systems and methods for storing information, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the systems and methods for storing information to allow users to manage files, and protected by the following claims.

Therefore, having thus described the invention, at least the following is claimed:

1. A coated fiber, comprising:
a core;
a cladding surrounding the core; and
an overlaying coating transparent to ultraviolet radiation surrounding and in direct contact with the cladding.

2. The coated fiber of claim 1, wherein the overlaying coating is a metal oxide coating.

3. The coated fiber of claim 2, wherein the metal oxide coating is at least one of vanadium oxide coating, aluminum oxide coating and titanium oxide coating.

4. The coated fiber of claim 3, wherein the aluminum oxide of the aluminum oxide coating has a hardness of 9 Mohs scale.

5. The coated fiber of claim 2, wherein the metal oxide coating is between zero and one micrometer thick.

6. The coated fiber of claim 2, further comprising a polymer coating surrounding the metal oxide coating.

7. The coated fiber of claim 2, wherein the metal oxide coating protects the core and the cladding against high temperatures, and wherein the high temperatures are temperatures greater than 150° centigrade and less than 500° centigrade.

8. A method for coating an optical fiber, comprising:
dipping the fiber in a solution to deposit a layer of a metal oxide; and
annealing the fiber to form a metal oxide coating on the fiber.

9. The method of claim 8, further comprising:
removing a polymer coating that is in direct contact with a cladding of the fiber, wherein the removing occurs before the dipping.

10. The method of claim 9, wherein the step of removing the polymer coating comprises immersing the fiber with the polymer coating in a hot acid to remove the polymer coating.

11. The method of claim 10, wherein the step of immersing comprises immersing the fiber with the polymer coating in one of hot sulfuric acid, hot hydrochloric acid, and hot nitric acid.

12. The method of claim 11, wherein the step of immersing the fiber with the polymer coating in the hot sulfuric acid comprises immersing the fiber with the polymer coating in a sulfuric acid at 140° centigrade for 30 seconds to remove the polymer coating on the fiber.

13. The method of claim 9, wherein the step of dipping comprises:
dipping the fiber in one of a metal alkoxide solution and an aqueous metal oxide solution.

14. The method of claim 13, further comprising:
preparing a metal oxide suspension by reacting a metal alkoxide with water; and
peptizing the metal oxide suspension with a concentrated acid to produce the aqueous metal oxide solution.

15. The method of claim 13, wherein the step of dipping the fiber in the metal alkoxide solution comprises dipping the fiber in one of vanadium isopropoxide solution, titanium isopropoxide solution, and aluminum isopropoxide solution.

16. The method of claim 15, wherein the step of dipping of fiber in the vanadium isopropoxide solution comprises dipping the fiber in the vanadium isopropoxide solution under an inert atmosphere.

17. The method of claim 13, wherein the step of dipping the fiber in the aqueous metal oxide solution comprises dipping the fiber in one of aqueous vanadium oxide solution, aqueous aluminum oxide solution, and aqueous titanium oxide solution.

18. The method of claim 13, wherein the step of dipping the fiber in the aqueous metal oxide solution comprises dipping the fiber in the aqueous metal oxide solution at room temperature.

19. The method of claim 9, further comprising cleansing the fiber after the removing but before the dipping.

20. The method of claim 19, wherein the step of cleansing comprises:
dipping the fiber in alcohol; and
providing an ultrasonic bath of alcohol to the fiber.

21. The method of claim 19, wherein the step of cleansing comprises:
dipping the fiber in alcohol; and
providing an ultrasonic bath of water to the fiber.

22. The method of claim 9, wherein the step of annealing the fiber comprises placing the fiber in a furnace between 200° centigrade and 400° centigrade to form the metal oxide coating on the fiber.

23. The method of claim 9, wherein the step of removing comprises removing one of acrylate coating and polyimide coating.

24. The method of claim 9, wherein the step of removing comprises heating the polymer coating to soften the polymer coating and then mechanically scraping the polymer coating.
